(19) United States
(12) Patent Application Publication
(10) Pub. No.: US 2007/0130962 A1
(43) Pub. Date: Jun. 14, 2007

(54) System and Method for Storing Cryogenic Liquid Air

(76) Inventor: Clayton E. Blalock, New Smyrna Beach, FL (US)

Correspondence Address: Robert L. Wolter;Beusse Brownlee Wolter Mora & Maire, P.A., Suite 2500, 390 North Orange Avenue, Orlando, FL, 32801, US

(21) Appl. No.: 11/608,349

(22) Filed: Dec. 8, 2006

Related U.S. Application Data
(60) Provisional application No. 60/749,404, filed on Dec. 12, 2005.

(51) Int. Cl. F17C 5/02

(52) U.S. Cl. 62/47.1

(57) ABSTRACT

An apparatus for storing liquid air (a cryogenic mixture of about 80% liquid nitrogen and about 20% liquid oxygen) in a stable condition within a storage vessel routes colder liquid nitrogen from an external source, through a condensing coil/heat exchanger that passes through the ullage space of the vessel. This will result in condensing the nitrogen-rich vapor into the mass as a liquid, thereby reducing ullage pressure, cooling the mass, and ultimately precluding oxygen-enrichment through boil-off.

This application claims priority based on Provisional Application No. 60/749,404 filed Dec. 12, 2005.

### FIELD OF THE INVENTION

The present invention relates to the storage and use of cryogenic liquids. More specifically, the invention pertains to systems and methods used for the storage and use of a cryogenic mixture of liquid nitrogen and liquid oxygen.

### BACKGROUND OF THE INVENTION

Some United States government agencies utilize sub-critical liquid air backpacks rather than standard self-contained breathing apparatuses (“SCBA”) to perform work in hazardous atmospheres. These liquid air backpacks include a cryogenic mixture of about 21% liquid oxygen (“LO_{2”}) and 79% liquid nitrogen (“LN₂”) as a source of breathable air. Because a system or method for storing bulk quantities of liquid air is not available, a cryogenic mixture of liquid air (up to 4,000 gallons at times) is manufactured within a known time period prior to performing a task that requires the use of the liquid air backpack. A liquid air supplied backpack used in a protective suit provides a source of breathable air for up to about two hours.

In comparison, a standard SCBA, used by first responders (firefighters etc.), utilizes a cylinder filled with compressed air and supplies breathable air for only one hour. Typically, the air supply in such suits will last only about thirty-five to forty minutes because the rate at which the air is consumed is dependant upon the demand. A responder, such as a firefighter, that is under stress will consume the air supply at a higher rate as compared to consumption of air under normal conditions.

Storage of multi-component cryogens is difficult, due to disproportionate boil-off rates of the components. Liquid nitrogen boils at −320° F., LO₂ boils at −275° F., and liquid air has a boiling point of −317° F. Since even the best insulated vessels allow some heat leak, and since LN₂ has a lower boiling point of the two components, the liquid nitrogen will tend to boil more rapidly. This excessive LN₂ boil-off results in oxygen enrichment of the stored liquid, as the nitrogen-rich vapor vents to atmosphere. Venting is necessary to prevent an overpressure of the storage vessel, or Dewar. As the more volatile nitrogen boils and is vented, the O₂/N₂ ratio changes. Ultimately, this increased oxygen content will render “life support grade” breathing air as an unusable fire hazard. Presently, bulk amounts of liquid air are stored for only up to about two weeks at which time any remaining liquid air must be discarded.

Systems have been used to store liquid oxygen in bulk amounts. Such a system is illustrated in FIG. 1, and includes a vacuum insulated vessel 10 in which LO₂ is stored. An external source of LN₂ is maintained in a second vessel 11 and is circulated in a pipe 12 through the ullage space 13 of vessel 10. As LO₂ evaporates, as a result of the vessel 10 heat leak, the O₂ vapor condenses on the pipe 12 thereby returning the vapor to liquid phase. The pipe 10 may be configured to wind back and forth in the ullage space above the LO₂ to increase the condensing surface area and thereby increase the amount of vapor condensed. In addition, one or more valves disposed between the first vessel 10 and second vessel 11 may be automated to open when the vapor pressure in vessel 10 reaches a predetermined upper limit, and close when the pressure is reduced to a predetermined lower limit.

The manufacture of liquid oxygen in air separation plants inherently produces a small amount of methane contaminants. If the methane concentration is too high the LO₂ cannot be used for some applications. Accordingly, the O₂ vapor in the ullage space of the vessel 10 is condensed to maintain the liquid methane below a predetermined concentration. However, such a system has never been used for storage of liquid air.

Systems and methods for storing liquid air are disclosed in various patents including, but not limited U.S. Pat. Nos. 3,260,060; 5,571,231; and, 5,778,680. Generally, these patents disclose a cryogenic mixture of LN₂ and LO₂ stored in a vessel that is adapted to condense the vapor in the ullage space of the vessel. The liquid air is drawn from the bottom of the vessel and re-circulated in a pipe disposed in the ullage space of the storage vessel to condense the vapor and return it to its liquid phase. However, such systems may not work well for storage of bulk amounts of liquid air because the temperature difference between the liquid air and vapor may be nominal. These systems may not condense a sufficient amount of vapor over an extended time period to maintain the appropriate concentrations of LN₂ and LO₂ to serve as a source of breathable air.

In as much as disasters, especially manmade disasters such as a biological, chemical or radiological disaster, may occur without warning, the first responders reaction time to the disaster is critical. First responders will not be able to wait for a cryogenic mixture of liquid air to be created. Accordingly, a need exists for a system and method for storing a cryogenic mixture of liquid air for an extended period of time for the purpose of making readily available to first responders a supply of liquid air to be used as an emergency response breathing supply. However, the system and method are not limited for use by first responders and may be included for any use that requires the storage of liquid air for an extended period of time.

### SUMMARY OF THE INVENTION

The present invention for the system and method employs the use of liquid nitrogen from an external source as the refrigerant for a condensing circuit. An apparatus for storing liquid air (a cryogenic mixture of about 80% liquid nitrogen and about 20% liquid oxygen) in a stable condition within a storage vessel routes colder liquid nitrogen from an external source, through a condensing coil/heat exchanger that passes through the ullage space of the vessel. This will result in condensing the nitrogen-rich vapor into the mass as a liquid, thereby reducing ullage pressure, cooling the mass, and ultimately precluding oxygen-enrichment through boil-off.

### BRIEF DESCRIPTION OF THE DRAWINGS

FIG. 1 is a schematic view of a prior art system for storing liquid oxygen.

FIG. 2 is a schematic view of a first embodiment of the invention.

FIG. 3 is a schematic view of a second embodiment of the invention.

FIG. 4 is a schematic a system of the present invention that circulates liquid air through a pump and pipe to the ullage space of storage vessel.

### DETAILED DESCRIPTION OF THE DRAWINGS

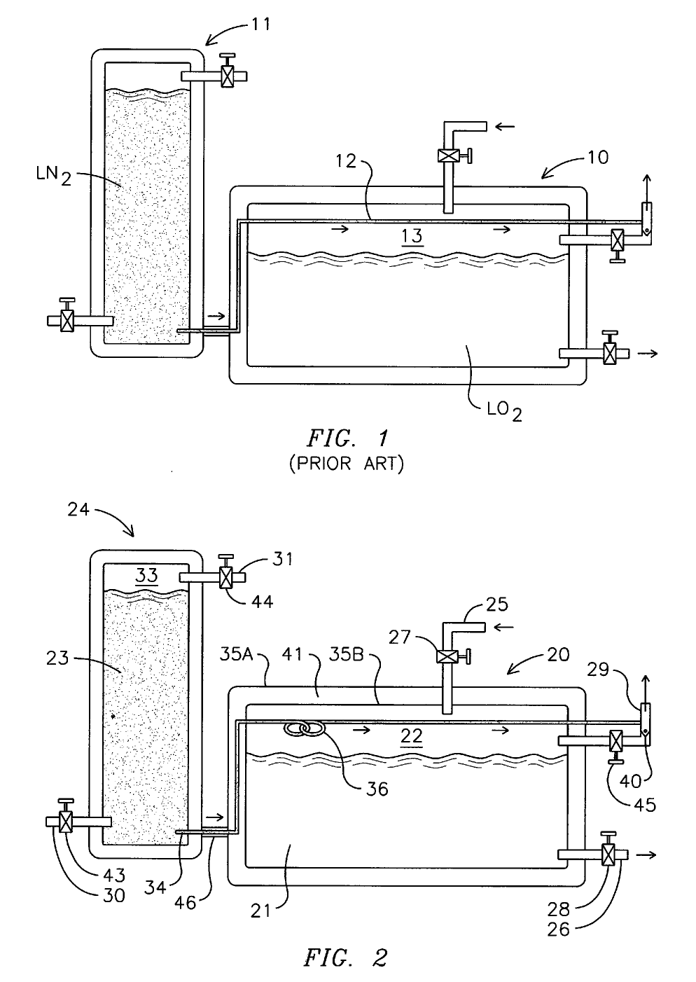

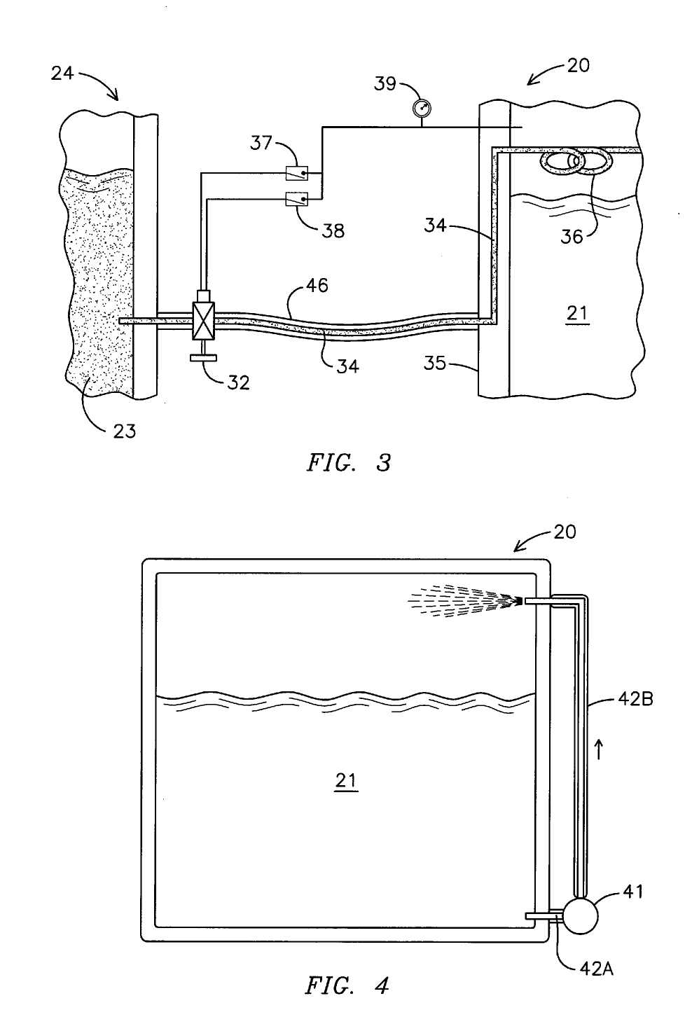

An embodiment for the present invention shown in FIGS. 2 and 3 utilizes a first storage vessel 20 in which a cryogenic mixture 21 of liquid nitrogen (LN₂) and liquid oxygen (LO₂) is stored. The mixture 21 may comprise about twenty percent (20%) LO₂ by volume and about eighty percent (80%) LN₂ by volume so that it may serve as a source of breathable for example in use with a self-contained breathing apparatus (“SCBA”); however, the concentrations may vary. Known safety standards for using a cryogenic mixture as a source of breathable include concentrations of LN₂ ranging from to about 76.5% to about 81.5% by volume of LN₂, and concentrations of LO₂ ranging from about 19.5% to about 23.5% by volume of LO₂. Such a mixture 21 may be stored at a pressure of about 40 pounds per square inch absolute (psia) at −300.01° F. to about 55 psia at −293.30° F.

The first vessel 20 includes an inlet/fill pipe 25 for providing the cryogenic mixture 21 therein and an outlet pipe 26 for providing the mixture 21 to a user. Control valves 27 and 28 control the flow of the mixture 21 in and out of the pipes 25 and 26 respectively. In addition, a vent pipe 29 is positioned on the first vessel 20 in communication with an ullage space or headspace 22 above the mixture 21 to vent gases to maintain the pressure in the vessel 20 within a predetermined pressure range. The vent pipe 29 may be opened and closed via flow control valve 45 However, this vent pipe 29 may be used minimally in the present system as condensing liquid air vapor in the ullage space 22 of the first vessel 20 can reduce the vapor pressure.

The vessel 20 is preferably a Dewar that is vacuum insulated. That is, the vessel 20 includes spaced apart double walls 35A and 35B with a vacuum 48 disposed there between for insulation of contents of the vessel 20. Despite the insulation of the vessel 20, there will exist some level of heat leak that will cause the mixture 21, or components thereof to evaporate to the ullage space (or head space) 22 above the cryogenic mixture 21.

Accordingly, a refrigerant 23 supplied via an external source, relative to the cryogenic mixture 21 in the vessel 20, is piped through the ullage space 22 of the first storage vessel 20 to condense the evaporated liquid air in the ullage space to the liquid phase. In an embodiment, the refrigerant 23 is liquid nitrogen that is stored in a second storage vessel 24. The LN₂ is preferably stored under pressure at about 20 psia at a temperature of about −315.55° F. The second vessel 24 includes an inlet/fill pipe 30 for providing the LN₂ therein and a vent pipe 31 that vents nitrogen vapor from an ullage space 33 of the second vessel 24. Control valves 43 and 44 control the flow of the liquid nitrogen into the vessel 24 and evaporated nitrogen out of the vessel 24 respectively.

With respect to FIG. 2, the LN₂ flows from the second vessel 24 through the first vessel 20 via a pipe 34. Thus the pipe 34 is in fluid flow communication with an interior of the second vessel 24 and LN₂ stored therein. That portion of the pipe 34 that extends from the second vessel 24 to the ullage space 22 of the first vessel 20 is preferably insulated in some fashion. In an embodiment shown in FIG. 2, the pipe 34 may include a vacuum insulated jacket 45, or have some other insulation mechanism, surrounding that portion of the pipe 34 disposed between the first vessel 20 and the second vessel 24. The pipe 34 is routed vertically through the vacuum insulated wall 35 of the vessel 20 for insulation of the pipe 34.

The pipe 34 may be positioned with respect to the first vessel 20 and second vessel, so the pipe 34 directly feeds from the second vessel 24 to the ullage space 22 of the first vessel 20 without routing the pipe through the vessel wall 35. However, with larger vessels having a storing capacity of 1,000 gallons, a stored liquid is typically drawn from the bottom of a vessel, so the pipe 34 may have to be routed vertically to reach the ullage space 22, and insulated accordingly. It may be that the second vessel 24 can be elevated with respect to the first vessel 20, so the bottom of second vessel 24 is aligned relative to the ullage space 22 so the pipe 34 can be fed directly into the ullage space 22 without the above-described routing.

With respect to FIG. 2 and 3, the pipe 34 may have a cooling coil 36 (or heat exchanger) to increase the surface of the pipe 34 within the ullage space 22 in order to capture more vapor for more efficient condensation. The pipe 34 may have other configurations such as winding back and forth in the ullage space 22 to create more surface area. At least that portion of the pipe 34 disposed within the ullage space 22 may fabricated from known materials such as stainless steel or copper. That portion of the pipe 34 disposed between first vessel 20 and second vessel 24 may be similarly composed of an insulated stainless steel or copper. Alternatively, the pipe 34 may include a vacuum insulated flex pipe or line as shown in FIG. 3.

The LN₂ is supplied through the pipe 34 on an as needed basis. More specifically, if the pressure within the first vessel 20 reaches, approaches or surpasses a predetermined upper pressure limit, the LN₂ is supplied through the pipe 34 until the pressure within the first vessel 20 reaches a predetermined lower pressure limit, or falls within an accepted pressure range. With respect to FIG. 3, a valve system including a solenoid 35 is positioned in communication with the pipe 34. A first switch 37 and second switch 38, preferably pressure switches, are placed in communication with a pressure gauge 39 that monitors the pressure within the first vessel 20 and in communication with the solenoid valve 35. The first switch 37 is activated to open the valve 35 when the pressure gauge 39 detects/measures a pressure within vessel 20 that reaches, approaches or exceeds a predetermined upper pressure level. When LN₂ flows through the pipe 34, and in particular through that portion of the pipe 34 that is disposed with the ullage space 22, liquid air vapor, and/or its vapor components nitrogen and oxygen, will condense on the pipe 34 returning to liquid phase in the vessel. In this manner concentration of LN₂ and LO₂ are maintained at acceptable levels relative to one another to store liquid air for extended periods of time as a source for breathable air.

As shown in FIG. 2, the pipe 34 exits the vessel 20 through walls 35 and is in fluid communication with the vent pipe 29. As the LN₂ passes through the pipe 34 the heat exchange that takes place between the pipe 34, LN₂ and air vapor in the ullage space 22 causes the LN₂ to vaporize into nitrogen gas, which is released through the vent pipe 29. A check valve 40 is preferable mounted in the vent pipe 29 between the wall 35 of vessel 29 and the point of entry of the pipe 34 and nitrogen relative to the vent pipe 29 to prevent a back flow of nitrogen into the vessel 20. Backflow of the nitrogen into the vessel should be avoided in order to maintain the relative concentrations of the liquid air 21 components.

In another embodiment shown in FIG. 4, a pump 41 and re-circulating pipe, including inlet 42A (with respect to the pump) and outlet pipe 42B (with respect to the pump 41) may be added to the system to avoid stratification of the liquid air mixture. More specifically, it is thought that over time the LN₂ and LO₂ may separate and stratify. Liquid oxygen is denser than LN₂ and would separate toward a bottom of the vessel 20, while the LN₂ migrate above the LO₂. To avoid this potential problem a pump 41 is positioned in fluid communication with a bottom end of the vessel 20. The pump 41 may be a typical centrifugal pump sized according to the size of the vessel. For example, for a 1,000-gallon vessel, a pump that is capable of drawing 5 gallons per minute of liquid air may be sufficient; and, for larger vessels, such as 4,000 gallon to 6,000 gallon vessels, the pump may be capable of drawing 30 gallons per minute of liquid air.

In this manner, the pump 41 draws the liquid air from the bottom of the vessel 20 and re-circulates the liquid into the vessel 20 through pipe 42B, by injecting the liquid into the ullage space 22. A spray nozzle (not shown) may be disposed on an end of the pipe 42B to inject the liquid air into the ullage space 22. In this manner, the liquid air 21 may be circulated to prevent stratification of the mixture's components, LN₂ and LO₂. In addition, the injection of the liquid air 21 into ullage space 22 may provide some immediate pressure relief because the temperature of the liquid air 21 is lower than the temperature within the vessel 10 at the ullage space 22. The pump 41 may draw the liquid air 21 continuously or at timed intervals as determined by a user. For example, the pump 41 may linked with pressure switches 37, 38, so that the pump is activated when the pressure within the first storage vessel 20 approaches, reaches or exceeds a pressure limit. In this manner, the liquid air 21 is injected into the ullage space 22 while the refrigerant 23 flows through the heat exchanger 36, aiding the refrigerant 23 in reducing the pressure within the first vessel 20, which may decrease the amount of time the LN₂ refrigerant is needed. When the pressure within the first storage vessel reaches or falls below the pressure limit, then the pump is deactivated.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What I claim as my invention is:

1. A system for storing a cryogenic mixture of liquid air, comprising:
a first insulated storage vessel containing a cryogenic mixture of liquid air comprising liquid nitrogen and liquid oxygen, and the liquid air is maintained within the first storage vessel at a first temperature;
a second insulated storage vessel containing a refrigerant that is maintained within the second storage vessel at a second temperature that is lower than the first temperature; and,
a heat exchanger positioned in a ullage space above the liquid air in the first storage vessel and in fluid communication with the second storage vessel, so the refrigerant passes through the heat exchanger causing vaporized air in the ullage space to condense and return to a liquid phase in the cryogenic mixture, and thereby reduce a pressure within the first storage vessel within a predetermined pressure range.

2. The system of claim 1 wherein the refrigerant is liquid nitrogen.

3. The system of claim 1 further comprising means, in fluid communication with the first storage vessel, for drawing an amount of the liquid air from the first storage vessel and injecting the drawn liquid air into the ullage space of the first storage vessel.

4. The system of claim 3 wherein the means for drawing and injecting, includes a centrifugal pump in fluid communication with the first storage vessel and liquid air therein via a first conduit, and in fluid communication with the ullage space via a second conduit.

5. The system of claim 1 wherein the liquid air components include about twenty percent liquid oxygen by volume and about eighty percent liquid nitrogen by volume.

6. The system of claim 1 wherein the concentration of liquid oxygen is maintained at a concentration ranging from about 19.5% to about 23.5% of by volume of liquid oxygen and liquid nitrogen is maintained at a concentration ranging from about 76.5% to about 81.5% by volume of liquid nitrogen.

7. The system of claim 1 wherein the liquid air is maintained within the first storage vessel within a pressure range from about and including 40 psia up to and including about 55 psia.

8. The system of claim 1 further comprising an automated valve system disposed between and in fluid communication with the first storage vessel and the second storage vessel that remains closed as the pressure within the first storage vessel is maintained within the predetermined pressure range or below a predetermined upper pressure limit and opens when the pressure within the first storage vessel exceeds the upper pressure limit to allow the refrigerant to flow through the ullage space of the first storage vessel.

9. A system for storing a cryogenic mixture of liquid air, comprising:
a first insulated storage vessel containing a cryogenic mixture of liquid air comprising liquid nitrogen and liquid oxygen, and the liquid air is maintained within the first storage vessel at a first temperature;
a second insulated storage vessel containing a refrigerant that is maintained within the second storage vessel at a second temperature that is lower than the first temperature;
a heat exchanger positioned in a ullage space above the liquid air in the first storage vessel and in fluid communication with the second storage vessel, so the refrigerant passes through the heat exchanger causing vaporized air in the ullage space to condense and return to a liquid phase in the cryogenic mixture, and thereby reduce a pressure within the first storage vessel within a predetermined pressure range; and,
a pump, in fluid communication with first storage vessel and the liquid air maintained therein and in fluid communication with the ullage space to inject liquid air from the first storage vessel into the ullage space thereof when the pressure within the first storage vessel approaches or exceeds a predetermined upper pressure limit within the first storage vessel.

10. The system of claim 9 further comprising an automated valve system disposed between and in fluid communication with the first storage vessel and the second storage vessel that remains closed as the pressure within the first storage vessel is maintained within the predetermined pressure range or below a predetermined upper pressure limit and opens when the pressure within the first storage vessel exceeds the upper pressure limit to allow the refrigerant to flow through the ullage space of the first storage vessel.

11. The system of claim 9 wherein the liquid air components include about twenty percent liquid oxygen and about eighty percent liquid nitrogen.

12. The system of claim 9 wherein the liquid air is maintained within the first storage vessel within a pressure range from about and including 40 psia up to and including about 55 psia.

13. A method for storing cryogenic mixture, comprising the steps of:
providing liquid air in a first storage vessel having a ullage space above the liquid air, and the liquid air comprising liquid oxygen and liquid nitrogen at predetermined concentration levels acceptable for use as breathable air, and the liquid air vaporizes into a gaseous phase within the ullage space;
providing a refrigerant in a second storage vessel;
providing a heat exchanger positioned in the ullage space of the vessel and the heat exchanger is in fluid communication with the second storage vessel and refrigerant therein; and,
passing the refrigerant through the heat exchanger to condense the vaporized liquid air within the ullage space of the tank thereby reducing a pressure within the first storage vessel below a predetermined limit and maintaining the acceptable concentration level of liquid nitrogen and liquid oxygen.

14. The method of claim 13 further comprising the steps of drawing liquid air from the first storage vessel when the pressure within the first storage vessel reaches or exceeds the predetermined pressure limit and injecting the air into the ullage space of the first storage vessel.

15. The method of claim 14 further comprising the step of discontinuing to draw liquid air from the first storage vessel when the pressure within the first storage level reaches or drops below the predetermined pressure limit.

16. The method of claim 13 wherein the predetermined pressure limit is about 55 psia.

17. The method of claim 13 wherein the concentration of the liquid nitrogen ranges from about 76.5% to about 81.5% by weight of liquid nitrogen and the concentration of liquid oxygen ranges from about 19.5% to about 23.5% by volume of liquid oxygen.
